(19) United States
(12) Patent Application Publication
(10) Pub. No.: US 2024/0224845 A9
(43) Pub. Date: Jul. 11, 2024

(54) SOIL MANIPULATING DEVICE AND METHOD OF MANUFACTURING SAME

(71) Applicant: Edward Lenart, Farmington Hills, MI (US)

(72) Inventor: Edward Lenart, Farmington Hills, MI (US)

(21) Appl. No.: 17/973,249

(22) Filed: Oct. 25, 2022

(51) Int. Cl. A01D 11/06; A01B 1/02; A01B 1/04; A01B 1/20; A01D 7/02; A01D 9/02; B21D 53/68

(52) U.S. Cl. CPC A01D 11/06; A01B 1/024; A01B 1/04; A01B 1/20; A01D 7/02; A01D 9/02; B21D 53/68

(57) ABSTRACT

A soil manipulating device for digging and raking soil includes a base plate, which defines a first plane and which has a first edge that is attached to a first end of a shaft. A set of tines is attached to and extends from a second edge of the base plate. Each tine defines an associated second plane and has opposed edges, which are serrated. At least one of the tines has an associated second plane which intersects the first plane. The shaft can be grasped in one or both hands of a user, positioning the user to insert the tines into soil to manipulate the soil by using the tines to cut into the soil. Various embodiments of soil manipulators can be used to perform a variety of digging and raking tasks while in a substantially upright posture and in a lowered posture, such as while sitting or knelling.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to soil manipulators and more particularly pertains to a new soil manipulator for digging and raking soil. The present invention discloses soil manipulators, each having a set of serrated tines, which are variously configured for digging and raking of soil by a user in substantially upright and lowered positions.

### (2) Description of Related Art Including Information Disclosed Under 37 CFR 1.97 and 1.98

The prior art relates to soil manipulators, which may comprise tools having multiple tines, rotating tools with blades or multiple sharpened tines, and tools having a single serrated edge perpendicular to a shaft. The prior art does not disclose a soil manipulator having a set of serrated tines.

### BRIEF SUMMARY OF THE INVENTION

An embodiment of the disclosure meets the needs presented above by generally comprising a base plate, which defines a first plane and which has a first edge that is attached to a first end of a shaft. A set of tines is attached to and extends from a second edge of the base plate. Each tine has opposed edges and defines an associated second plane. The opposed edges are serrated. At least one of the tines has an associated second plane which intersects the first plane. The shaft is configured to be grasped in one or both hands of a user, positioning the user to insert the tines into soil to manipulate the soil. The opposed edges of the tines are configured to cut into the soil. Various embodiments of soil manipulators are configured to allow a user to perform a variety of digging and raking tasks while in a substantially upright posture and in a lowered posture, such as while sitting or knelling.

Another embodiment of the disclosure includes a method of manufacturing a soil manipulating device, as described in the disclosure above, wherein the base plate, the extension plates, and the tines are formed from a single slab. The slab is formed into a precursor plate, which is cut to form the base plate, a set of extension plates extending from the base plate, and a set of tines, each extending from a respective extension plate. Each tine is tapered, to define a tip, and serrated along each of its opposed edge. Each extension plate then is twisted to achieve a desired configuration of the tines, and a shaft is attached to the base plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a soil manipulating device according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is a side view of an embodiment of the disclosure.

FIG. 6 is an isometric perspective view of an embodiment of the disclosure.

FIG. 7 is an isometric perspective view of an embodiment of the disclosure.

FIG. 8 is an isometric perspective view of an embodiment of the disclosure.

FIG. 9 is an isometric perspective view of an embodiment of the disclosure.

FIG. 10 is a side view of an embodiment of the disclosure.

FIG. 11 is a top view of an embodiment of the disclosure.

FIG. 12 is an isometric perspective view of an embodiment of the disclosure.

FIG. 13 is a front view of an embodiment of the disclosure.

FIG. 14 is a bottom view of an embodiment of the disclosure.

FIG. 15 is an isometric perspective view of an embodiment of the disclosure.

FIG. 16 is a side view of an embodiment of the disclosure.

FIG. 17 is a bottom view of an embodiment of the disclosure.

FIG. 18 is an isometric perspective view of an embodiment of the disclosure.

FIG. 19 is an isometric perspective view of an embodiment of the disclosure.

FIG. 20 is an isometric perspective view of an embodiment of the disclosure.

FIG. 21 is a front view of an embodiment of the disclosure.

FIG. 22 is a side view of an embodiment of the disclosure.

FIG. 23 is an isometric perspective view of an embodiment of the disclosure.

FIG. 24 is a flow diagram for a method of manufacturing an embodiment of the disclosure.

### DETAILED DESCRIPTION OF THE INVENTION

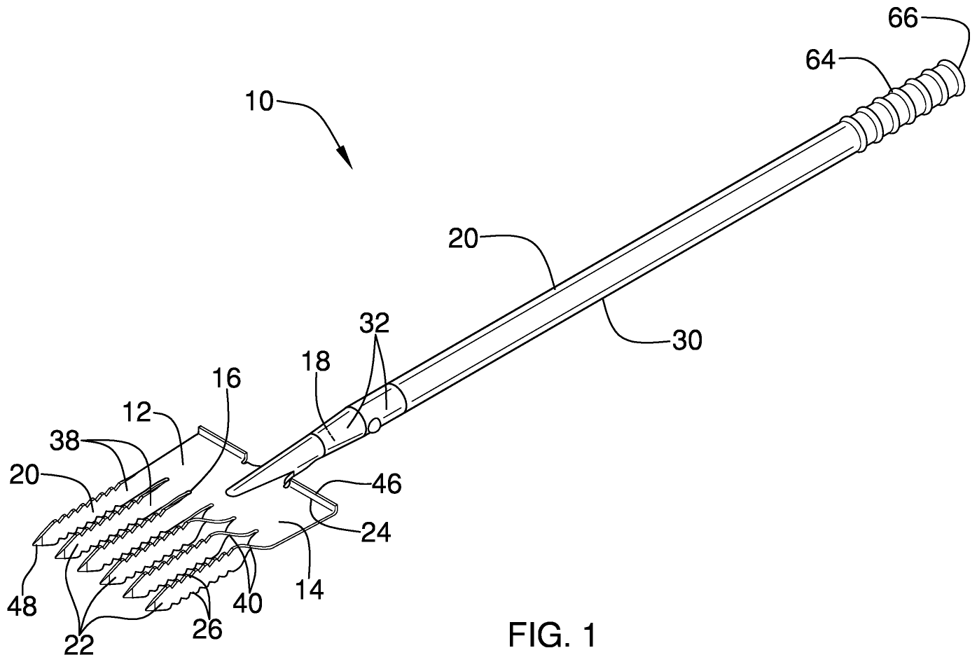

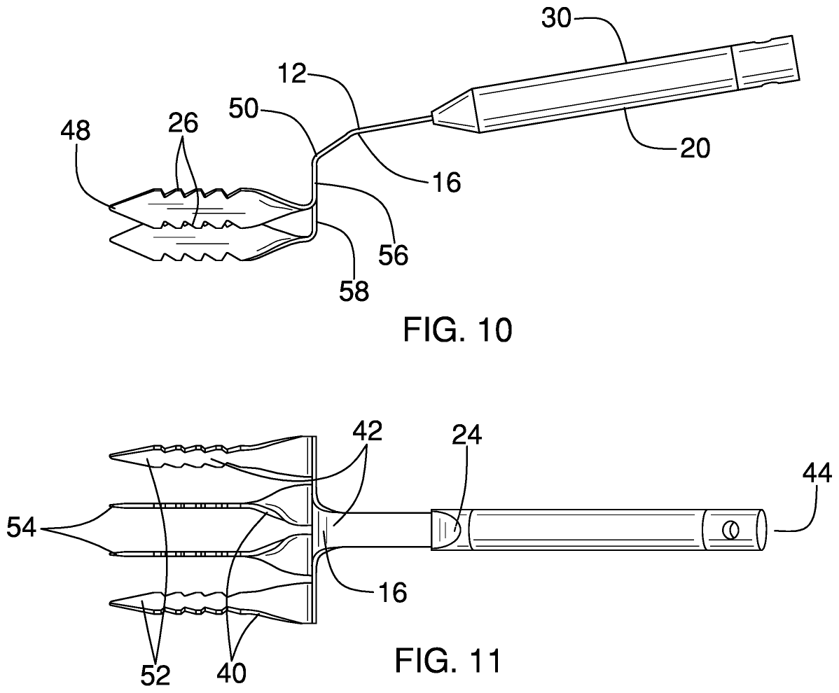

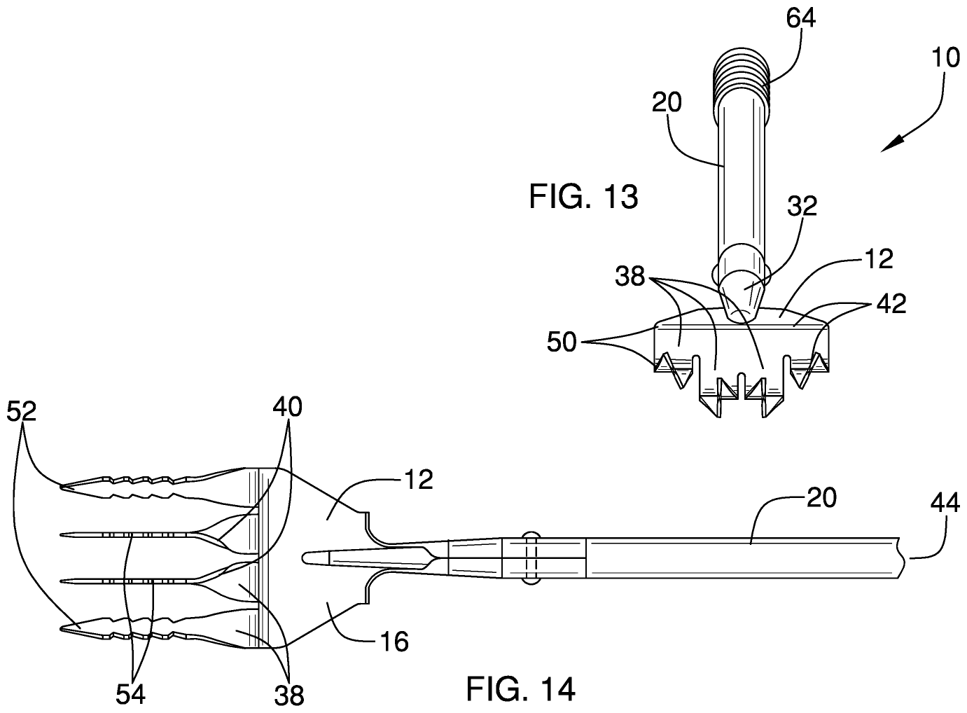

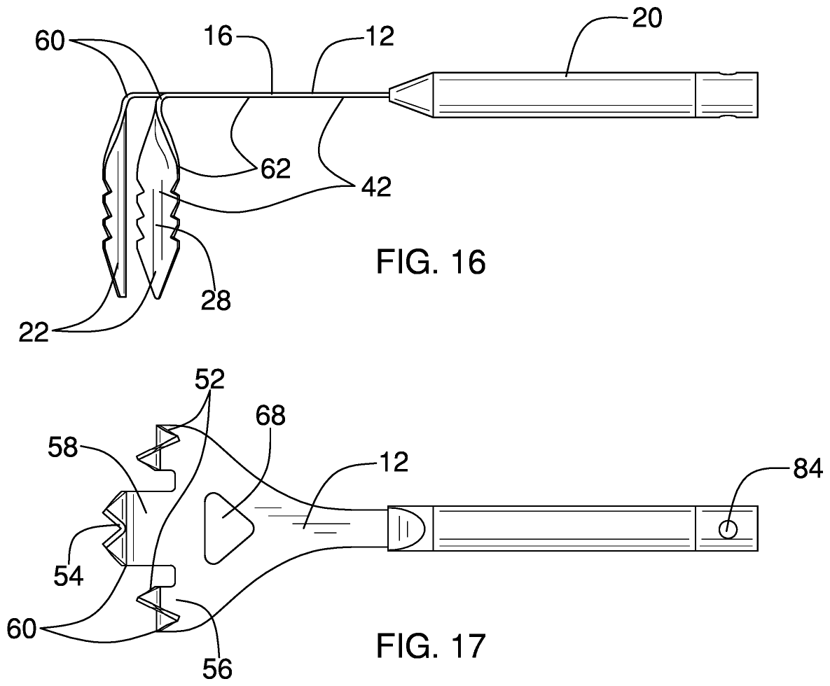

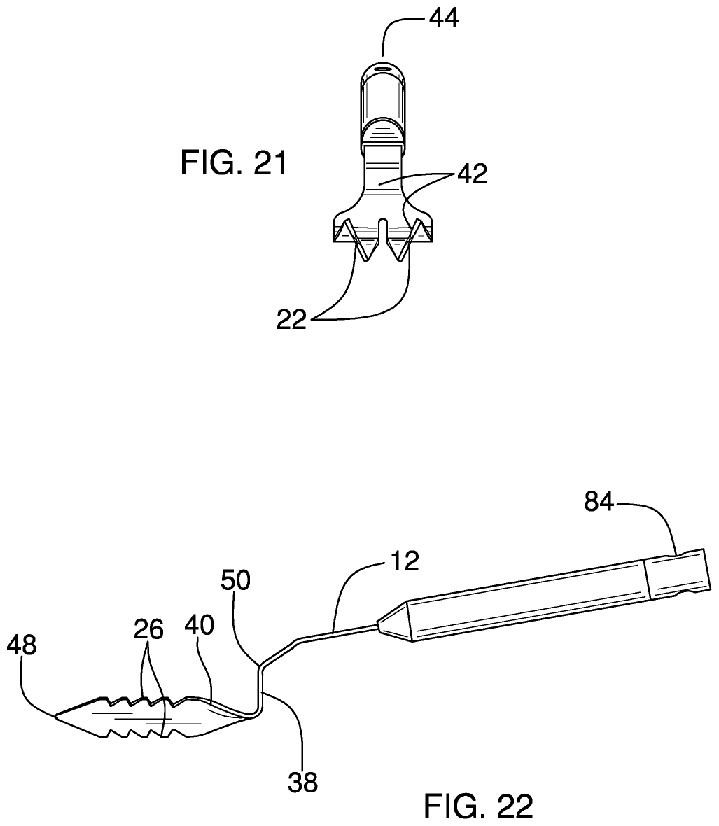

With reference now to the drawings, and in particular to FIGS. 1 through 23 thereof, a new soil manipulator embodying the principles and concepts of an embodiment of the disclosure and generally designated by the reference numeral 10 will be described.

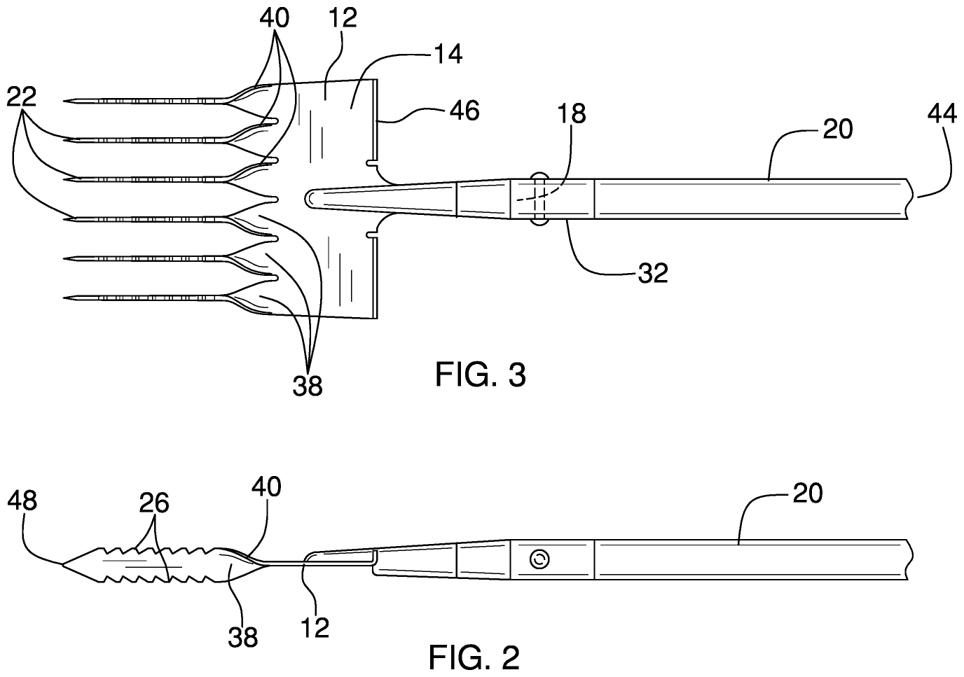

As best illustrated in FIGS. 1 through 23, the soil manipulating device 10 generally comprises a base plate 12, which defines a first plane 14 and which has a first edge 16 that is attached to a first end 18 of a shaft 20. A set of tines 22 is attached to and extends from a second edge 24 of the base plate 12. Each tine 22 has opposed edges 26 and defines an associated second plane 28. Both of the opposed edges 26 may be serrated, as is shown in FIG. 2, although the present invention also anticipates only one of the opposed edges 26 being serrated, one opposed edge 26 being serrated with the other opposed edge 26 being sharpened, and any combination of these configurations amongst the set of tines 22.

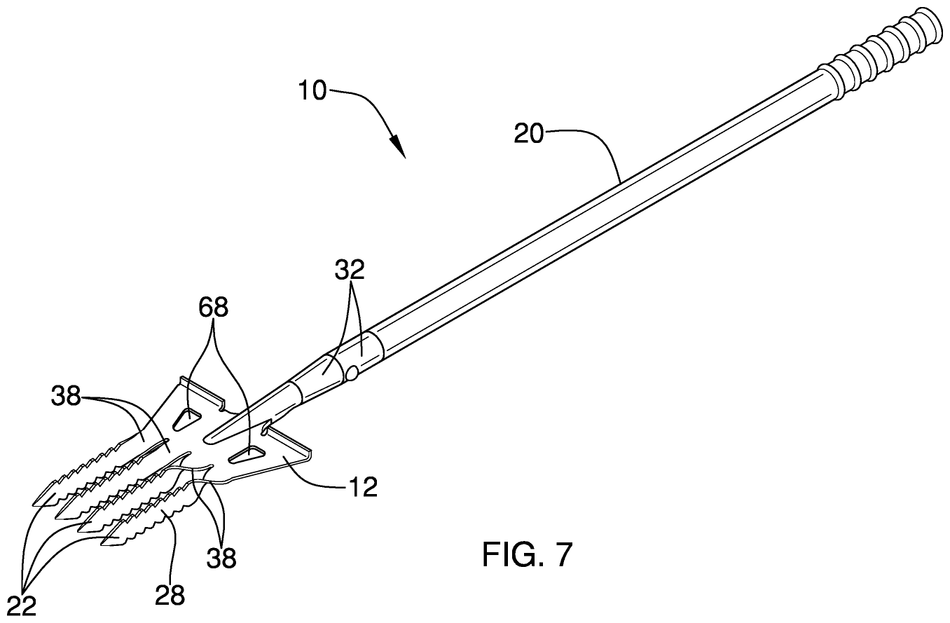

The set of tines 22 comprises from one to twenty eight tines 22. As is shown in FIGS. 1 and 7, the set of tines 22 comprises six tines 22 and four tines 22, respectively. As is shown in FIGS. 7-12, FIGS. 13-18, and FIGS. 19-22, the set of tines 22 comprises four tines 22, three tines 22, and two tines 22, respectively. It is anticipated that soil manipulating device 10 wherein the set of tines 22 includes more tines 22, for example, sixteen tines 22, twenty four tines 22, and the like, would be useful in cleaning landscaping and in raking leaves, broken branches, weeds, weeds roots, and the like.

At least one of the tines 22 has an associated second plane 28 which intersects the first plane 14. The shaft 20 is configured to be grasped in one or both hands of a user, positioning the user to insert the tines 22 into soil to manipulate the soil. The opposed edges 26 of the tines 22 are configured to cut into the soil. The present invention is anticipated to provide an efficient and cost effective device for manipulating soil in small areas and in areas which otherwise cannot be accessed by mechanized tillers, such as a rototiller.

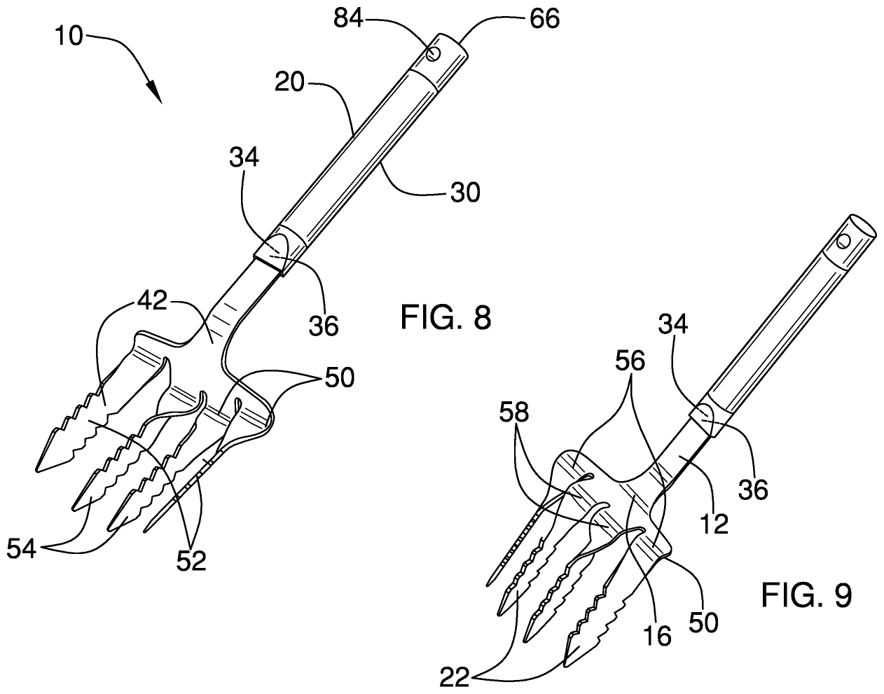

The shaft 20 of each soil manipulating devices 10 may be of a length 30 sufficient to allow a user to perform a variety of digging and raking tasks while in a substantially upright posture, such as the shafts 20 shown in FIGS. 1, 6, 12, and 18. The shaft 20 of each soil manipulating devices 10 also may be of a length 30 sufficient to allow a user to perform a variety of digging and raking tasks while in a lowered posture, such as while sitting or knelling, as is shown for the shafts 20 in FIGS. 8, 13, 15, and 19.

The present invention anticipates the shaft 20 being engaged to the base plate 12 by means of a socket 32, which may be riveted to the shaft 20, as is shown in FIGS. 3, 4, and 14, by means of a portion 34 of the base plate 12 extending into a notch 36 in the shaft 20, as is shown in FIGS. 8, 15, and 19, and other attachment means known to those skilled in that art of attaching handles to tools.

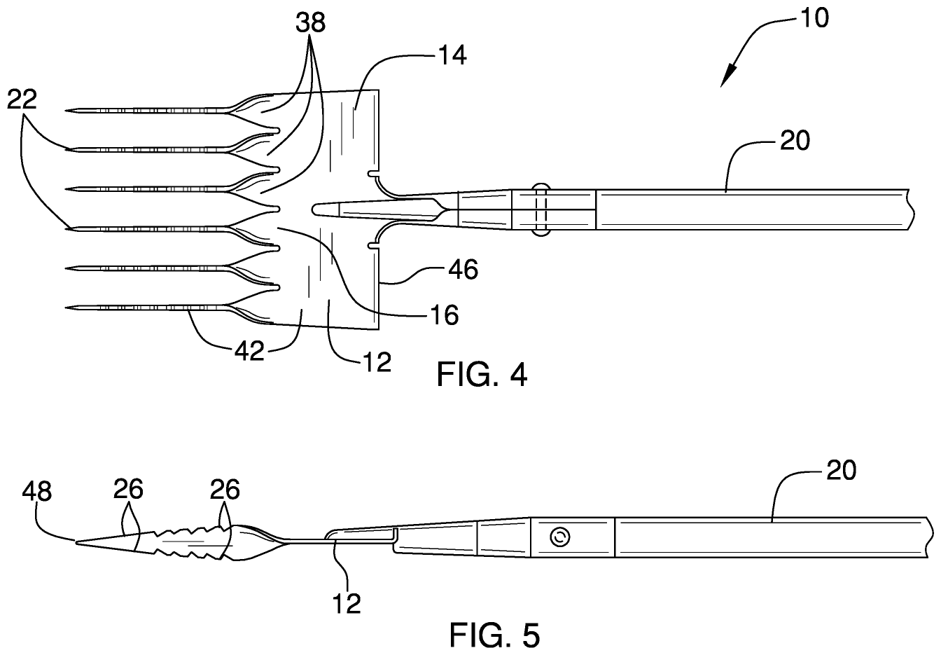

Each extension plate 38 of a set of extension plates 38 is attached to and positioned between the second edge 24 of the base plate 12 and a respective tine 22. Each twist 40 of a set of twists 40 is positioned in a respective extension plate 38 so that an associated tine 22 has an associated second plane 28 at an angle 42 measuring from 0.0° to 90.0° relative to the first plane 14. The twists 40 may be positioned such that the set of tines 22 and the set of extension plates 38 are bisected by a plane of symmetry 44, as is shown in FIGS. 4, 11, 14, and 21. In FIG. 4, the plane of symmetry 44 bisects the shaft 20 and is perpendicular to the first plane 14. The extension plates 38, by being twisted, provide for robust attachment of the tines 22 to the base plate 12.

The present invention anticipates other means for connecting the tines 22 to the base plate 12. For example, the tines 22 could be attached to an attachment plate (not shown), which is attached to the second edge 24 of the base plate 12 and which extends angularly from the base plate 12, either omnidirectionally or bidirectionally.

Various embodiments of soil manipulating devices 10, which are presented in further detail below, are configured to allow the user to perform a variety of digging and raking tasks while in a substantially upright posture and in a lowered posture, such as while sitting or knelling.

For the soil manipulating devices 10 shown in FIGS. 3, 4 and 7, each tine 22 has an associated second plane 28 at an angle 42 relative to the first plane 14 measuring from 88.0° to 90.0°, that is, the second planes 28 are substantially perpendicular to the first plane 14. The shafts 20 of the soil manipulating devices 10 shown in these Figures are of a length 30 sufficient to allow the user to perform a variety of digging tasks while in an upright position. The shafts 20, being longer, allow the user to lever the tines 22 back and forth in the soil, wherein the tines 22 break up the soil.

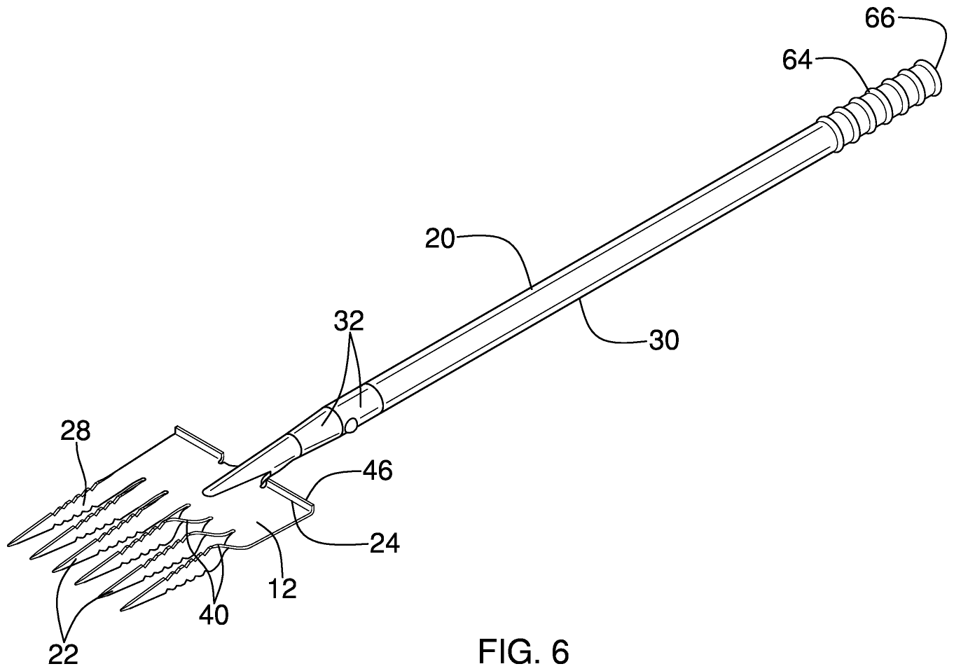

As is shown in FIG. 2, a lip 46 is attached to and extends from the first edge 16 of the base plate 12. The lip 46 is configured to allow for positioning of a foot of the user, thereby enabling the user to push the tines 22 into the soil. As is shown in FIG. 6, each tine 22 tapers from proximate to the base plate 12 to a tip 48 of the tine 22 so that the opposed edges 26 are separated less proximate to the tip 48 than proximate to the base plate 12. This tapering of the tines 22 facilitates their insertion into harder or more compacted soil.

As is shown in FIGS. 8-14 and 19-22, each S-curve 50 of a plurality of S-curves 50 is positioned in a respective extension plate 38 so that an associated tine 22 is offset from the base plate 12 and is substantially parallel planer with the base plate 12. As is shown in FIGS. 8-14, the set of tines 22 comprises a bracketing pair 52 and a central set 54. Each tine 22 of the bracketing pair 52 has an associated second plane 28 at an angle 42 measuring from 40.0° to 65.0° relative to the first plane 14. The central set 54 is bracketed by the tines 22 of the bracketing pair 52. Each tine 22 of the central set 54 has an associated second plane 28 at an angle 42 measuring from 88.0° to 90.0° relative to the first plane 14.

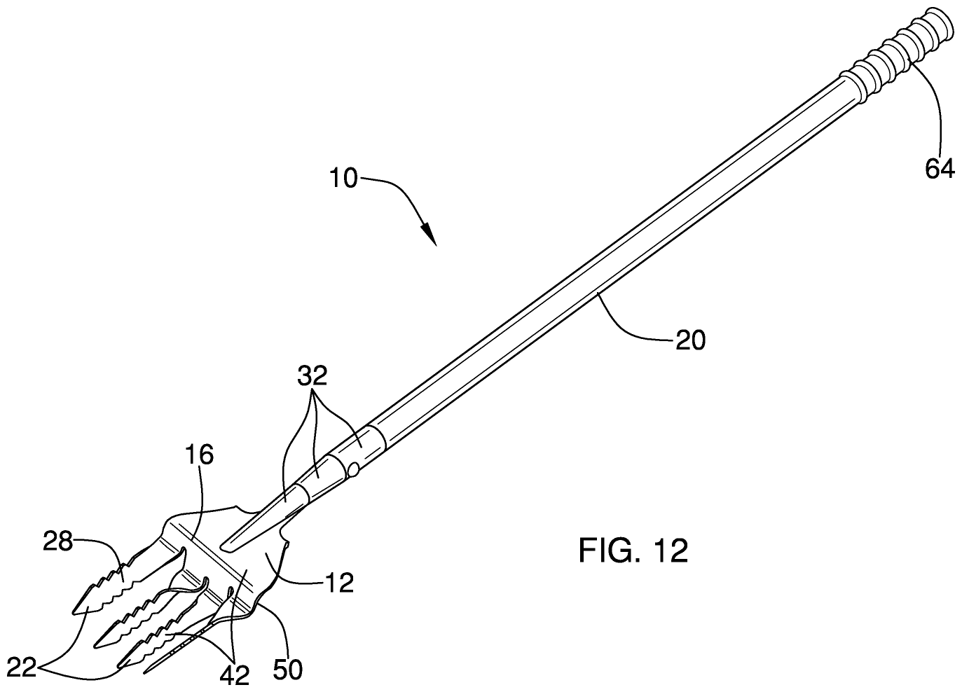

The configuration of the tines 22 as shown in FIGS. 8-14, wherein the central set 54 comprises two tines 22, is particularly useful in digging and mixing the soil. The shaft 20 of the soil manipulating device 10 shown in FIGS. 12-14 is of a length 30 sufficient to allow the user to perform these tasks while in an upright position, whereas the shaft 20 of the soil manipulating device 10 shown in FIGS. 8-11 is of a length 30 sufficient to allow the user to perform these tasks while in a lowered position.

As is shown in FIGS. 8-14, the set of extension plates 38 comprises a flanking pair 56 and a medial set 58, which is bracketed by the flanking pair 56. Each extension plate 38 of the medial set 58 is dimensionally longer than the extension plates 38 of the flanking pair 56 so that the set of tines 22 is nonplanar. This staggered offsetting of the tines 22 relative to the base plate 12 also facilitates mixing of the soil.

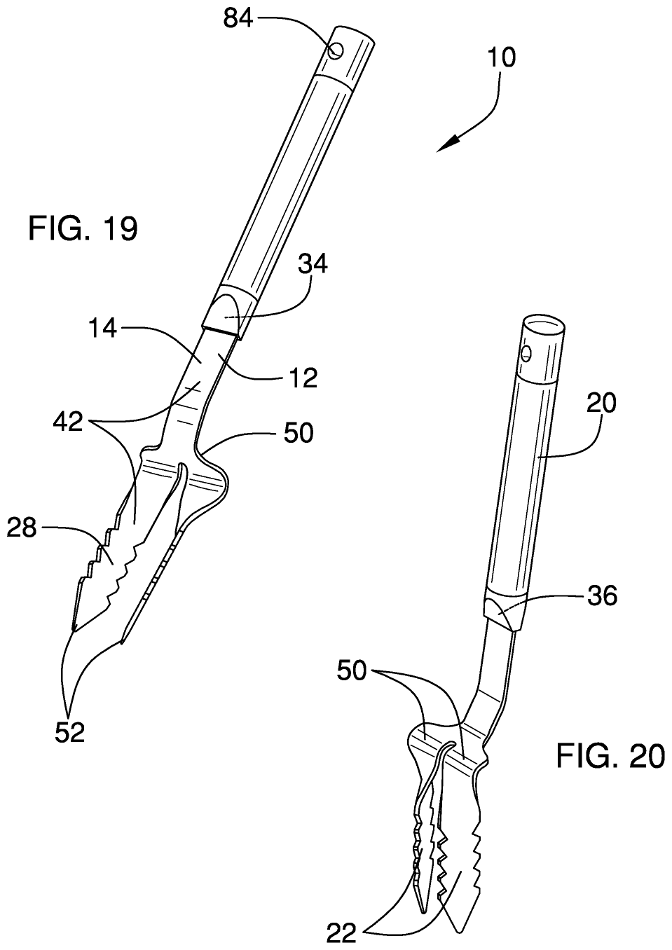

As is shown in FIGS. 19-22, the central set 54 comprises zero tines 22, providing a soil manipulating devices 10 having a configuration of particular use for digging holes for seeds, for digging up seedlings for transplanting, and for digging up weeds. The shaft 20 of the soil manipulating device 10 shown in FIGS. 19-22 is of a length 30 sufficient to allow the user to perform these tasks while in a lowered position.

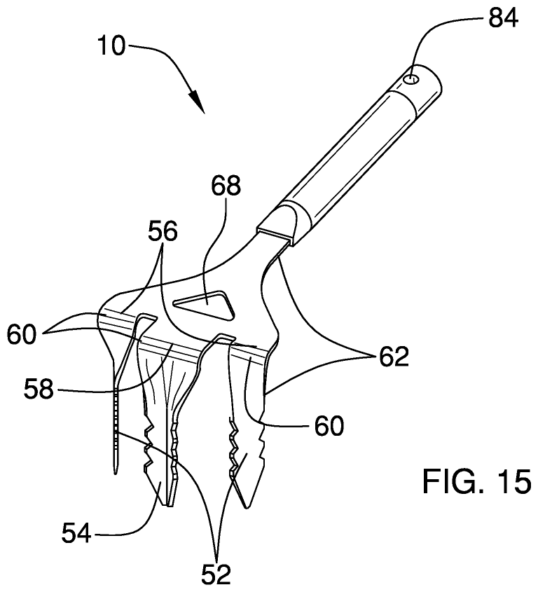

As is shown in FIGS. 15-18, each bend 60 of a set of bends 60 is positioned in a respective extension plate 38 so that an associated tine 22 is at an angle 62 that measures from 45.0° to 135.0° relative to the base plate 12. For example, the angle 62 may measure 88.0 to 90.0°. The set of tines 22 again comprises a bracketing pair 52 and a central set 54. Each tine 22 of the bracketing pair 52 has an associated second plane 28 at an angle 42 measuring from 40.0° to 65.0° relative to the first plane 14. The central set 54 is bracketed by the tines 22 of the bracketing pair 52. The central set 54 may comprise one tine 22 having a V-shaped cross-section, or other number of tines 22, such as, one to four tines 22, which are planar and which have associated second planes 28 at a variety of angles 42 relative to the first plane 14.

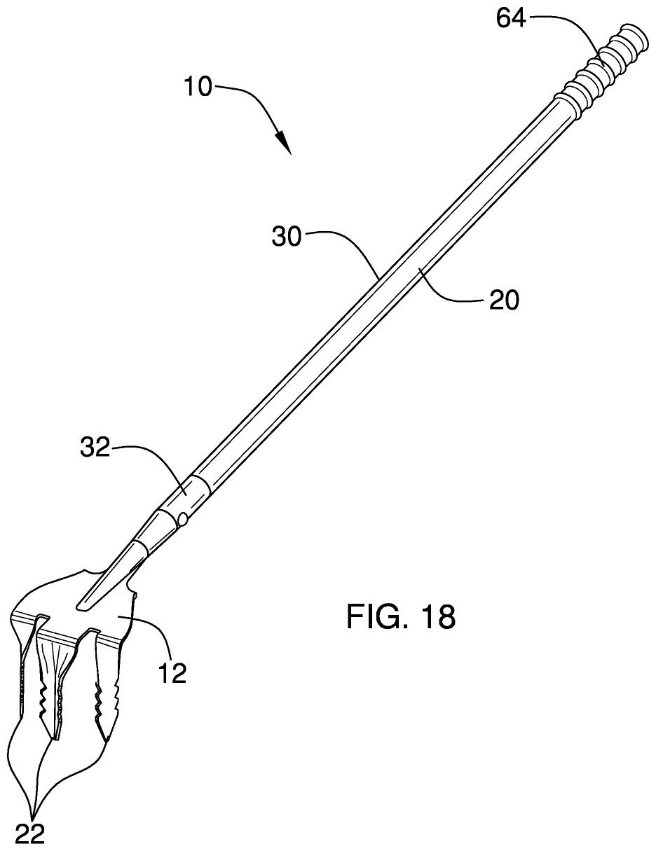

Soil manipulating devices 10 of the configuration shown in FIGS. 15-18 are of particular use in raking and mixing soil. The shaft 20 of the soil manipulating device 10 shown in FIG. 18 is of a length 30 sufficient to allow the user to perform these tasks while in an upright position, whereas the shaft 20 of the soil manipulating device 10 shown in FIGS. 15-17 is of a length 30 sufficient to allow the user to perform these tasks while in a lowered position.

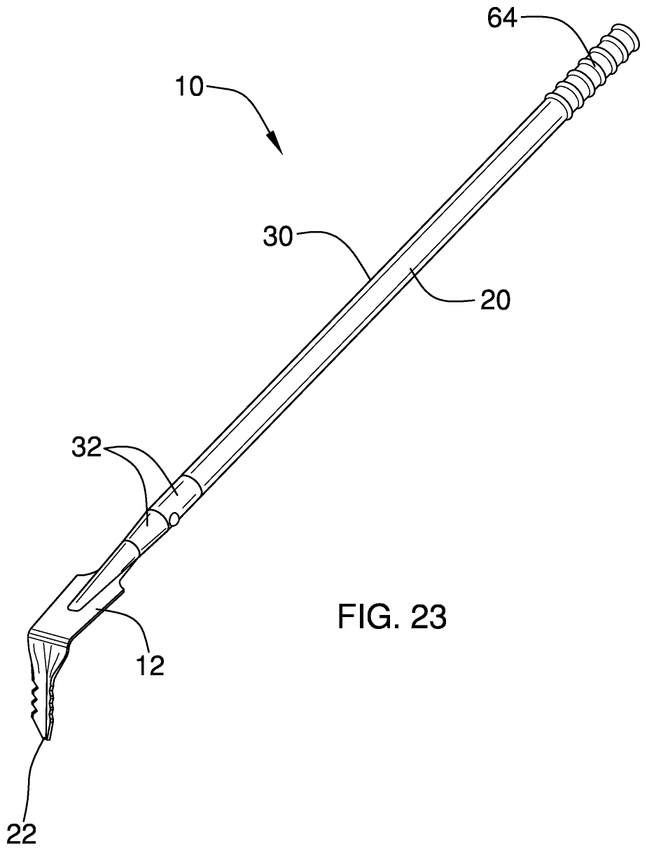

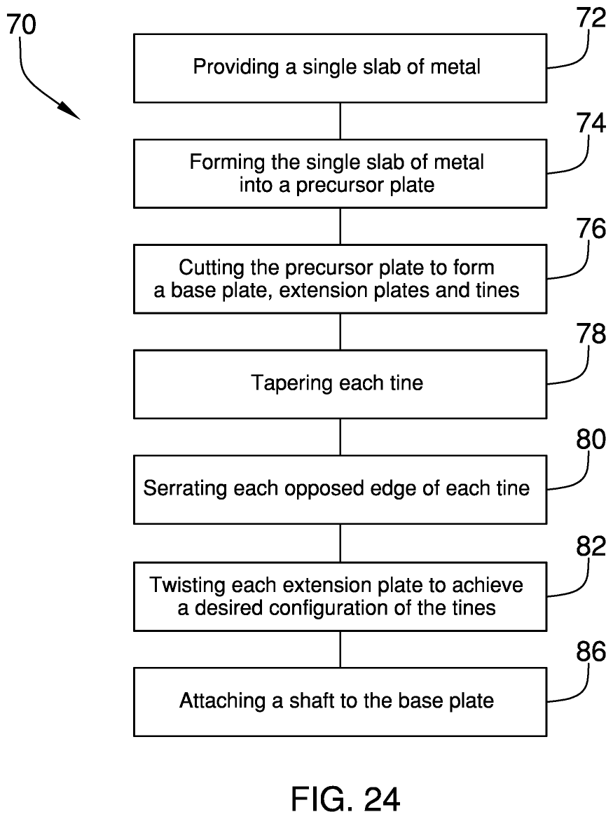

Another iteration of the soil manipulating devices 10 is shown in FIG. 23, wherein the set of tines 22 comprises one tine 22, which has a V-shaped cross-section and is anticipated to be useful in creating a furrow for planting a row of seeds. The shaft 20 of the soil manipulating device 10 shown in FIG. 23 is of a length 30 sufficient to allow the user to create furrows while in an upright position. The present invention also anticipates the shaft 20 being of a length 30 sufficient to allow the user to create furrows while in a lowered position.

As is shown in FIGS. 15-18, the set of extension plates 38 again comprises a flanking pair 56 and a medial set 58, which is bracketed by the flanking pair 56. Each extension plate 38 of the medial set 58 is dimensionally longer than the extension plates 38 of the flanking pair 56 so that the set of tines 22 is nonplanar. This staggered offsetting of the tines 22 also facilitates mixing of the soil while raking.

As shown in FIGS. 1, 6, 7, 12, and 13, a grip 64 is attached to the shaft 20 proximate to a second end 66 of the shaft 20. The grip 64 to configured for enhance a grasp of a user upon the shaft 20 and may comprise rubber, silicone, elastomer, or the like. As is shown in FIGS. 7, 15, and 17, a set of cutouts 68 is positioned in the base plate 12. The cutouts 68 are configured to facilitate a rocking/levering motion of the base plate 12 and the tines 22 within the soil by allowing the soil to pass through the base plate 12. As is shown in FIG. 19, the present invention also anticipates a hole 84 positioned through the shaft 20 distal from the base plate 12 for hanging the soil manipulating devices 10 for storage.

The present invention also anticipates a method of manufacturing a soil manipulating device 70, as described in the specification above, wherein the base plate 12, the extension plates 38, and the tines 22 are formed from a single slab of metal (not shown), such as steel, stainless steel, or the like. The method 70 comprises a provision step 72, which entails providing a single slab of metal. A first forming step 74 is forming the single slab of metal into a precursor plate (not shown) having an overall length substantially equivalent to that of a base plate 12, a set of extension plates 38, and a set of tines 22. A second forming step 76 is cutting the precursor plate to form the base plate 12, a set of extension plates 38 extending from a second edge 24 of the base plate 12, and a set of tines 22, each extending from a respective extension plate 38. A third forming step 78 is tapering each tine 22 distal from an associated extension plate 38 to define a tip 48 of the tine 22. A fourth forming step 80 is serrating each opposed edge of each tine 22. A fifth forming step 82 is twisting each extension plate 38 to achieve a desired configuration of the tines 22. As will be apparent to those skilled in the art of tool manufacturing, the ordering of the “forming steps” of the method 70 can be varied. A finishing step 86 of the method 70 is attaching a shaft 20 to the base plate 12 so that the shaft 20 extends opposingly from the set of extension plates 38.

Additionally, the third forming step of method 70 may entail tapering of the tine 22 from the tip 48 of the tine 22 to proximate to its associated extension plate 38. The method 70 may include an additional step of selectively bending each extension plate 38 so that an associated tine 22 extends from the extension plate 38 at an angle 62 measuring from 45.0° to 135.0° relative to the base plate 12. Alternatively, the method 70 may include an additional step of forming an S-curve 50 in each extension plate 38 so that an associated tine 22 is offset from and substantially parallel planer with the base plate 12.

In use, the shaft 20 is grasped in one or both hands of a user and the tines 22 are inserted into soil to manipulate the soil. Depending on the configuration of the soil manipulating device 10, manipulation of the soil is performed with a digging motion or a raking motion and from a substantially upright or lowered position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A soil manipulating device comprising:
a shaft;
a base plate having a first edge attached to a first end of the shaft, the base plate defining a first plane; and
a set of tines attached to and extending from a second edge of the base plate, each tine having opposed edges and defining an associated second plane, at least one of the tines having an associated second plane intersecting with the first plane, the opposed edges being serrated, wherein the shaft is configured for grasping in one or both hands of a user, positioning the user for inserting the tines into soil for manipulating the soil.

2. The soil manipulating device of claim 1, wherein the set of tines comprises from one to twenty eight tines.

3. The soil manipulating device of claim 1, wherein each tine has an associated second plane at an angle relative to the first plane measuring from 88.0° to 90.0°.

4. The soil manipulating device of claim 1, further including a lip attached to and extending from the first edge of the base plate, wherein the lip is configured for positioning of a foot of the user, positioning the user for pushing the tines into the soil.

5. The soil manipulating device of claim 1, wherein each tine tapers from proximate to the base plate to a tip of the tine, such that the opposed edges are separated less proximate to the tip than proximate to the base plate.

6. The soil manipulating device of claim 1, further including:
a set of extension plates, each extension plate being attached to and positioned between the second edge of the base plate and a respective tine; and
a set of twists, each twist being positioned in a respective extension plate such that an associated tine has an associated second plane at an angle measuring from 0.0° to 90.0° relative to the first plane.

7. The soil manipulating device of claim 6, wherein the base plate, the extension plates, and the tines are formed from a single slab.

8. The soil manipulating device of claim 6, further including:
a set of S-curves, each S-curve being positioned in a respective extension plate, such that an associated tine is offset from and substantially parallel planer with the base plate;
the set of tines comprising:
a bracketing pair, each tine of the bracketing pair having an associated second plane at an angle measuring from 40.0° to 65.0° relative to the first plane; and
a central set bracketed by the tines of the bracketing pair, each tine of the central set having an associated second plane at an angle measuring from 88.0° to 90.0° relative to the first plane.

9. The soil manipulating device of claim 8, wherein the set of extension plates comprises:
a flanking pair; and
a medial set bracketed by the flanking pair, each extension plate of the medial set being dimensionally longer than the extension plates of the flanking pair, such that the set of tines is nonplanar.

10. The soil manipulating device of claim 9, wherein the medial set comprises zero tines.

11. The soil manipulating device of claim 6, further including:
a set of bends, each bend being positioned in a respective extension plate, such that an associated tine is at an angle measuring from 45.0° to 135.0° relative to the base plate;
the set of tines comprising:
a bracketing pair, each tine of the bracketing pair having an associated second plane at an angle measuring from 40.0° to 65.0° relative to the first plane; and
a central set bracketed by the tines of the bracketing pair.

12. The soil manipulating device of claim 11, wherein the set of extension plates comprises:
a flanking pair; and
a medial set bracketed by the flanking pair, each extension plate of the medial set being dimensionally longer than the extension plates of the flanking pair, such that the set of tines is nonplanar.

13. The soil manipulating device of claim 11, wherein the central set comprises one tine having a V-shaped cross-section.

14. The soil manipulating device of claim 11, wherein the set of tines comprises one tine having a V shaped cross-section.

15. The soil manipulating device of claim 1, further including a grip attached to the shaft proximate to a second end of the shaft, wherein the grip is configured for enhancing a grasp of a user upon the shaft.

16. The soil manipulating device of claim 1, further including a set of cutouts positioned in the base plate, wherein the cutouts are configured for facilitating a rocking motion of the base plate and the tines within the soil.

17. A method of manufacturing a soil manipulating device comprising the steps of:
providing a single slab of metal;
forming the single slab of metal into a precursor plate having an overall length substantially equivalent to that of a base plate, a set of extension plates, and a set of tines;
cutting the precursor plate to form the base plate, a set of extension plates extending from the base plate, and a set of tines, each extending from a respective extension plate;
tapering each tine distal from an associated extension plate to define a tip of the tine;
serrating each opposed edge of each tine;
twisting each extension plate to achieve a desired configuration of the tines, and
attaching a shaft to the base plate, such that the shaft extends opposingly from the set of extension plates.

18. The method of claim 17, wherein tapering of the tine is extended from the tip of the tine to proximate to its associated extension plate.

19. The method of claim 17, further including an additional step of selectively bending each extension plate such that an associated tine extends from the extension plate at an angle measuring from 45.0° to 135.0° relative to the base plate.

20. The method of claim 17, further including an additional step of forming an S-curve in each extension plate, such that an associated tine is offset from and substantially parallel planer with the base plate.
